(19) United States
(12) Patent Application Publication
(10) Pub. No.: US 2002/0015442 A1
(43) Pub. Date: Feb. 7, 2002

(54) Digital transmitter-receiver

(76) Inventors: Seiichi Takeuchi, Osaka (JP); Masakazu Nishino, Osaka (JP); Masaaki Kobayashi, Hyogo (JP)

Correspondence Address: RATNER AND PRESTIA, Suite 301, One Westlakes, Berwyn, P.O. Box 980, Valley Forge, PA, 19482-0980, US

(21) Appl. No.: 09/866,280

(22) Filed: May 25, 2001

(30) Foreign Application Priority Data
May 26, 2000 (JP) 2000-156333

(51) Int. Cl. H04B 3/36

(52) U.S. Cl. 375/211

(57) ABSTRACT

A digital transmitter-receiver comprises a receiving unit for receiving digital data transmitted in accordance with a first transmission protocol, a transcoder for converting the received digital data to data in accordance with a second transmission protocol, and a transmitting unit for transmitting output data from the transcoder to a terminal apparatus. The transmitting unit monitors a transmission state and informs the transcoder of a monitoring result. Based on the monitoring result, the transcoder changes data rate.

### BACKGROUND OF THE INVENTION

1. Field of the Invention

The present invention relates to a digital transmitter-receiver that transmits received digital data using a transmission protocol different from a transmission protocol at receiving time.

2. Description of the Related Art

A conventional data communication device or data communication system that communicates data between different protocols is shown in, for example, Japanese Patent Laid Open No. 2000-59459. This conventional technology comprises a first apparatus for transmitting/receiving data through radio in accordance with a first protocol, and a data communication device for communicating data with a second protocol through a bus in accordance with a second protocol. The technology also comprises converting means for converting a format between the data in accordance with the first protocol and the data in accordance with the second protocol.

In the prior art discussed above, however, the converting means for converting the first protocol to the second protocol functions in a uniquely determined conversion format, but does not function adequately to a receiving state.

### SUMMARY OF THE INVENTION

The present invention addresses the problems discussed above. A digital transmitter-receiver in accordance with the present invention comprises a receiving unit for receiving digital data transmitted using a first transmission protocol, a transcoder for converting the received digital data to data in accordance with a second transmission protocol, and a transmitting unit for transmitting data supplied from the transcoder to a terminal apparatus. The transmitting unit monitors the transmission state and informs the transcoder of the monitoring result. Based on the monitoring result, the transcoder changes data rate of the received digital data.

### BRIEF DESCRIPTION OF THE DRAWINGS

FIG. 1 is a block diagram of a digital transmitter-receiver in accordance with exemplary embodiment 1 of the present invention.

FIG. 2 is a block diagram of a digital transmitter-receiver in accordance with exemplary embodiment 2 of the present invention.

FIG. 3 is a block diagram of a digital transmitter-receiver in accordance with exemplary embodiment 3 of the present invention.

### DESCRIPTION OF THE PREFERRED EMBODIMENTS

(Embodiment 1)

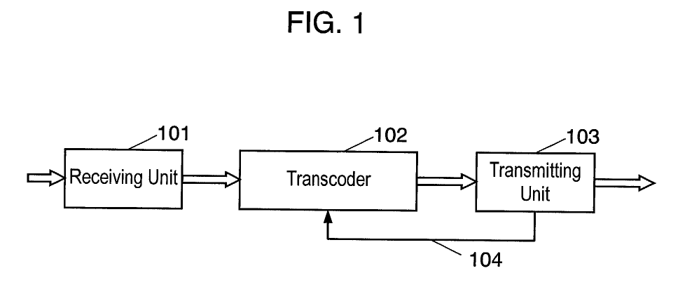

Referring to FIG. 1, a digital transmitter-receiver in accordance with exemplary embodiment 1 of the present invention will be described hereinafter. Receiving unit 101 receives digital data transmitted via radio or a wire using a first transmission protocol such as Code Division Multiple Access (CDMA).

Transcoder 102 converts digital data transmitted in accordance with the first transmission protocol to that in accordance with a second transmission protocol such as Transmission Control Protocol/Internet Protocol (TCP/IP).

Transmitting unit 103 transmits digital data to a receiving terminal (not shown) using the second protocol. Transmitting unit 103 monitors the transmission state, and feeds back monitoring result 104 to transcoder 102. The feedback is performed, for example, at 0.5 seconds interval.

Based on monitoring result 104, transcoder 102 changes transmission rate of the digital data so that it is adapted to the transmission state.

When transmittable bit rate reaches 5 Mbps less than 10 Mbps at the start of the transmission or during the transmission by transmitting unit 103 of a 10 Mbps Moving-Picture-Experts-Group (MPEG) transport stream encoded by an MPEG-2, transcoder 102 is informed of the situation. Based on the information, transcoder 102 thins out pictures in a video stream separated from the transport stream, or a high frequency component of a Discrete Cosine Transform (DCT) coefficient. A 5 Mbps MPEG transport stream formed by multiplexing an audio stream and a reduced video stream is outputted.

Accordingly, an apparatus or device (not shown) on the receiving side can continuously receive video without interruption.

When a buffer is disposed between transcoder 102 and transmitting unit 103 and temporarily stores the output from transcoder 102, sufficient measures are allowed for change of the transmission state.

(Embodiment 2)

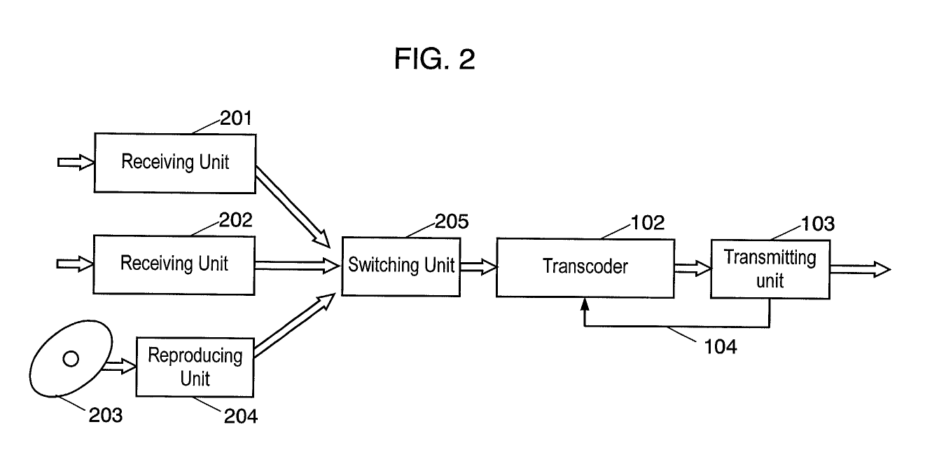

Referring to FIG. 2, a digital transmitter-receiver in accordance with exemplary embodiment 2 of the present invention will be described hereinafter. The digital transmitter-receiver in accordance with embodiment 2 differs from the digital transmitter-receiver of embodiment 1 in FIG. 1 in that the transmitter-receiver in FIG. 2 comprises a plurality of receiving units and a switching unit for selecting at least one of the receiving units.

Receiving unit 201 receives digital data transmitted in accordance with a transmission protocol employing, for example, Coded Orthogonal Frequency Division Multiplex (COFDM).

Receiving unit 202 receives digital data transmitted in accordance with a transmission protocol employing, for example, 8 Vestigial Side Band (8VSB) modulation. Reproducing unit 204 reproduces digital data recorded on recording medium 203.

Switching unit 205 selects and outputs at least one of digital data supplied from receiving units 201, 202 and reproducing unit 204. This selection is performed by an operation of an operation unit (not shown) in the digital transmitter-receiver. Otherwise, a command is fed from a receiving terminal (not shown) to the digital transmitter-receiver, and then this selection may be performed responsive to the command.

Transcoder 102 converts the digital data supplied from switching unit 205 to that in accordance with a second transmission protocol.

Transmitting unit 103 transmits an output of transcoder 102 via radio or a wire. Transmitting unit 103 also has a function of monitoring the transmission state to the receiving terminal (not shown).

Transcoder 102 receives the monitoring result of the transmission state from transmitting unit 103. Based on the monitoring result, transcoder 102 changes transmission rate of the outputted digital data so that the rate is adapted to the transmission state. In other words, transmitting unit 103 includes a so-called self-monitoring function of monitoring its own transmission state, and informs transcoder 102 of the monitoring result. Transcoder 102 receives the information and changes the data rate. When transmittable bit rate reaches 5 Mbps less than 10 Mbps at the start of the transmission or during the transmission of a 10 Mbps MPEG transport stream by transmitting unit 103, transcoder 102 is informed of the situation. Based on the information, transcoder 102 thins out pictures in a video stream separated from the MPEG transport stream, or a high frequency component of a DCT coefficient. Audio streams are multiplexed, and an MPEG transport stream less than 5 Mbps is outputted. Accordingly, a receiving terminal (not shown) can continuously receive video without interruption.

When a buffer is disposed between transcoder 102 and transmitting unit 103 and temporarily stores the output from transcoder 102, sufficient measures are allowed for change of the transmission state.

The present embodiment addresses two systems of receiving units, but is not limited to such receiving units. The embodiment may have more receiving units. The present embodiment is not limited to only one combination of a reproducing unit and a recording medium, but may have several combinations.

(Embodiment 3)

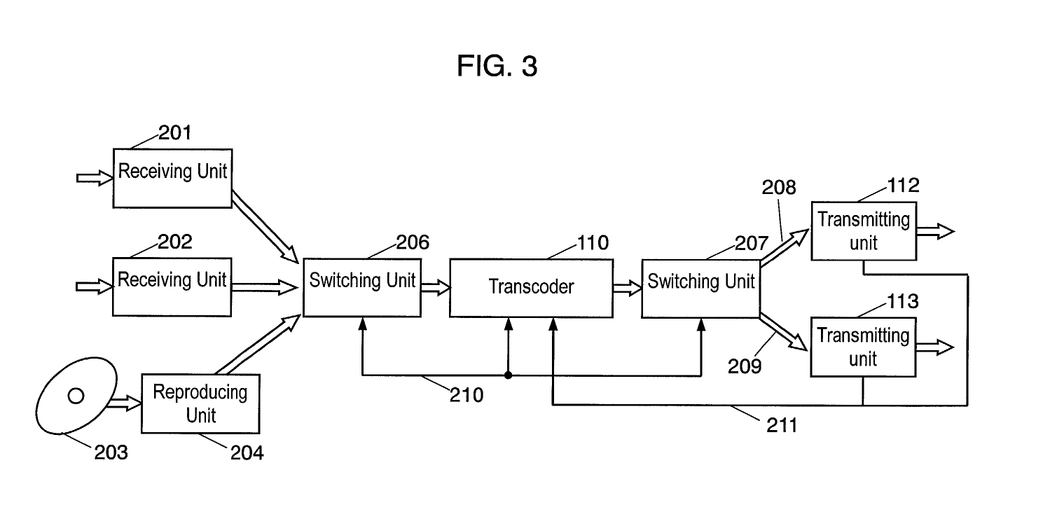

Referring to FIG. 3, a digital transmitter-receiver in accordance with exemplary embodiment 3 of the present invention will be described hereinafter.

Receiving units 201 receives digital data transmitted in accordance with a transmission protocol employing, for example, COFDM. Receiving unit 202 receives digital data transmitted in accordance with a transmission protocol employing, for example, 8VSB. Reproducing unit 204 reproduces digital data recorded on recording medium 203. Switching unit 206 selects and outputs at least one of digital data supplied from receiving units 201, 202 and reproducing unit 204. This selection is performed by an operation of an operation unit (not shown) in the digital transmitter-receiver. Otherwise, a command is fed from a receiving terminal (not shown) to the digital transmitter-receiver, and then this selection may be performed responsive to the command.

An output of switching unit 206 is fed into transcoder 101, and an output of transcoder 110 is fed into switching unit 207. The switching unit 207 includes two contacts. A first contact is connected to transmitting unit 112, and a second contact is connected to transmitting unit 113. Transcoder 110 has a function same as functions of embodiment 1 and embodiment 2. A line 210 in FIG. 3 shows that there is a relation among switching unit 206, switching unit 207, and transcoder 110. What an operator of the digital transmitter-receiver of the present invention selects from receiving unit 201, receiving unit 202, and recording medium 203 using switching unit 206 determines an input condition of transcoder 110. Additionally, what the operator selects from transmitting unit 112 and transmitting unit 113 using switching unit 207 determines an output condition of transcoder 110. In other words, same number of conditions of transcoder 110 as number of combinations between first protocols corresponding to a plurality of receiving units and second protocols corresponding to a plurality of transmitting units are set.

In embodiment 3, for example, first receiving unit 201 receives a broadcasting satellite (BS) digital broadcast, its transmission protocol is 8VSB, and its bit rate is 10 Mbps. Second receiving unit 202 receives a ground-wave digital broadcast, its transmission protocol is COFDM, and its bit rate is 20 Mbps. Recording medium 203 is digital versatile disc (DVD), and reproducing unit 204 is DVD player.

Additionally, it is assumed that a transmission protocol transmitted by transmitting unit 112 is white cap and a transmission protocol transmitted by transmitting unit 113 is digital white cap.

Receiving unit 201 8VSB-demodulates the BS digital broadcast, and selects an MPEG-2 transport stream (hereinafter called TS) in a predetermined channel. Next, receiving unit 201 demultiplexes TS, and outputs an MPEG-2 elementary stream (hereinafter called ES) of video signals and audio signals. Bit rate of the ES is assumed to be 10 Mbps.

Receiving unit 202 decodes received wave of COFDM, and demodulates a carrier in a predetermined channel. Receiving unit 202 then demultiplexes an MPEG-2 TS in the predetermined channel, and outputs an MPEG-2 ES of video signals and audio signals. Bit rate of the ES is assumed to be 20 Mbps.

Reproducing unit 204 reproduces and decodes an MPEG-2 program stream recorded on recording medium 203, and outputs an MPEG-2 ES of video signals and audio signals. Bit rate of the ES is assumed to be 6 Mbps.

When the protocol is white cap, the bit rate is preferably 10 Mbps, 6 Mbps in a steady state, or less than 6 Mbps in a bad transmission state.

When the protocol is digital white cap, the bit rate is ideally 50 Mbps, 20 Mbps in the steady state, or less than 20 Mbps in the bad transmission state.

When an audience or an administrator of the digital transmitter-receiver requests, for example, “I want to watch a channel of a BS digital broadcast with a white-cap-capable terminal” under the condition discussed above, switching unit 206 selects the output from receiving unit 201. Transcoder 110 converts video signals and audio signals with 10 Mbps supplied from receiving unit 201 to those with a bit rate corresponding to a transmission state supplied from transmitting unit 112, and outputs them. The output from transcoder 110 is fed into transmitting unit 112 through switching unit 207.

When the audience or the administrator of the digital transmitter-receiver requests, “I want to watch a channel of a ground-wave digital broadcast with a digital-white-cap-capable terminal”, switching unit 206 selects the output from receiving unit 202. Transcoder 110 converts video signals and audio signals with a total of 20 Mbps supplied from receiving unit 202 to those with a bit rate corresponding to a transmission state supplied from transmitting unit 113, and outputs them. The output from transcoder 110 is fed into transmitting unit 113 through switching unit 207.

The selection of transmitting unit 112 or transmitting unit 113 is performed by an operation of an operating unit (not shown) of the digital transmitter-receiver. Otherwise, a command is supplied from a receiving terminal (not shown) to the digital transmitter-receiver, and then this selection may be performed responsive to the command. Transcoder 110 converts the protocol depending on the selection state of switching units 206, 207.

Transcoder 110 may change syntax, a packet, or a flag as well as the bit rate discussed above. The syntax is a data structure determined by a transmission standard. The packet is a transmission unit having a predetermined header so as to provide a synchronizing function. The packet is generally divided as a header part and a payload part. The header part has a data group required mainly for synchronization during the transmission. The payload part has data such as audio or video to be essentially transmitted. Additionally, the transmission data includes many kinds of flags. For example, when bit rate is converted by frame thinning, a flag representing frame rate is changed. At this time, a plurality of flags corresponding to changes before and after the transcoding must be changed.

Transmitting units 112, 113 can use a protocol other than those discussed above, such as Ethernet or Bluetooth.

Both transmitting units 112, 113 have a function capable of recognizing and self-monitoring the data transmission state to a terminal. The transmitting units 112, 113 inform transcoder 110 of the transmission state at a predetermined time interval such as 0.5 seconds. Transcoder 110 receives the information of the transmission state of transmitting unit 112 or transmitting unit 113, and changes data rate responsive to the information. This change is substantially same as those discussed in embodiment 1 and embodiment 2.

When transmittable bit rate reaches 5 Mbps less than 10 Mbps at the start of the transmission or during the transmission of a 10 Mbps MPEG transport stream by transmitting unit 112 or transmitting unit 113, transcoder 102 is informed of the situation. Based on the information, transcoder 102 thins out pictures in a video stream or a high frequency component of a DCT coefficient. Audio streams are multiplexed, and an MPEG transport stream less than 5 Mbps is outputted. Accordingly, a receiving terminal (not shown) can continuously receive video without interruption.

The embodiment of the present invention is not limited to the digital transmitter-receiver discussed above. For example, transmitting unit 112 or transmitting unit 113, if has storing means for temporarily storing transmitted information (a transmission state), can successively perform a self-monitoring function.

The embodiment of the present invention addresses two systems of receiving units 201, 202, but may have more receiving units. The embodiment is not limited to only one combination of reproducing unit 203 and recording medium 204, but may have several combinations. Additionally, the embodiment is not limited to two systems of transmitting units 112, 113.

The embodiment of the present invention is hitherto described, but the transmission protocol may be a radio transmission standard such as Infrared Data Association (IrDA) or Bluetooth as well as OFDM, VSB, CDMA, white cap, or digital white cap. Additionally, the transmission protocol may be a wire transmission standard such as Local Area Network (LAN) or Point to Point Protocol (PPP), for example, Ethernet, TCP/IP, Integrated Service Digital Network (ISDN), Data Link Control (DLC), Fiber Distributed Data Interface (FDDI), NetWare, or Appletalk.

The digital data comprises video signals, audio signals, character or picture information, or program data to be performed by a computer. The digital data may also comprise data encoded responsive to a compression algorism determined by MPEG standard, Joint-Photographic-Experts-Group standard, or H263.

Additionally, the embodiment may include a buffer function of adjusting time delay. The embodiment, using the buffer, may delay the audio signals by a transcode processing period of the video signals, or the video signals by a transcode processing period of the audio signals. The receiving unit, the recording medium, and reproducing unit may be integrated. The recording medium may be a disk or a tape.

As discussed above, the digital transmitter-receiver in accordance with the present invention transmits data in accordance with different protocols, converts a first protocol to a second protocol, self-monitors a transmission state, feeds back the monitoring result to a transcoder, and changes the protocol and data rate. The present invention can thus provide the digital transmitter-receiver corresponding to various protocols and transmission states.

The digital transmitter-receiver can receive a digital television (TV) broadcast or a streaming broadcast on Internet, and transmit it to a plurality of terminals in a house. Its practical effect is large.

What is claimed is:

1. A digital transmitter-receiver comprising:
a receiving unit for receiving digital data transmitted in accordance with a first transmission protocol;
a transcoder for converting the received data to data in accordance with a second transmission protocol; and
a transmitting unit for transmitting output data from said transcoder to a terminal apparatus,
wherein said transmitting unit monitors a transmission state and informs said transcoder of the transmission state,
wherein said transcoder, based on the transmission state, changes and outputs data rate of the digital data.

2. The digital transmitter-receiver according to claim 1 further comprising a first switching unit,
wherein number of said receiving units is plural,
wherein said first switching unit selects the digital data received by said plurality of receiving units, and feeds the digital data to said transcoder.

3. The digital transmitter-receiver according to claim 2 further comprising a second switching unit,
wherein number of said transmitting units is plural,
wherein output from said transcoder is fed into a transmitting unit selected by said second switching unit.

4. The digital transmitter-receiver according to claim 2,
wherein said first switching unit selects one of said plurality of receiving units responsive to a request of the terminal apparatus.

5. The digital transmitter-receiver according to claim 3,
wherein said first switching unit selects one of said plurality of receiving units responsive to a request of the terminal apparatus.

6. The digital transmitter-receiver according to claim 3,
wherein said second switching unit selects one of said plurality of transmitting units responsive to a request of the terminal apparatus.

7. The digital transmitter-receiver according to claim 5,
wherein said second switching unit selects one of said plurality of transmitting units responsive to a request of the terminal apparatus.

8. The digital transmitter-receiver according to one of claim 1 through claim 7,
wherein the digital data is a first MPEG transport stream,
wherein said transcoder separates a video elementary stream and an audio elementary stream from the MPEG transport stream, reduces data rate of the video elementary stream by at least one of thinning of a picture from the video elementary stream and thinning of a high frequency component of a discrete-cosine-transform (DCT) coefficient, and outputs a second MPEG transport stream by multiplexing the video elementary stream after the rate reduction and the audio elementary stream.
